(19) United States
(12) Patent Application Publication
(10) Pub. No.: US 2010/0199210 A1
(43) Pub. Date: Aug. 5, 2010

(54) Item Setting Device, Control Method and Control Program for the Device

(75) Inventors: Seiji Harada, Tokyo (JP); Rei Yokoyama, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/687,302

(22) Filed: Jan. 14, 2010

(30) Foreign Application Priority Data
Jan. 19, 2009 (JP) 2009-009033

(51) Int. Cl. G06F 3/048

(52) U.S. Cl. 715/777

(57) ABSTRACT

The editable tab selectably displayed as well as the fixed tabs is selected by the user, whereby an editable tab screen is created and displayed using the display item information on which item should be displayed on the editable tab screen, the display position information on the position of the item to be displayed on the editable tab screen, and the item information of item included in the fixed tab.

This application is based on Japanese Patent Application No. 2009-009033 filed on Jan. 19, 2009 with Japanese Patent Office, the entire content of which is hereby incorporated by reference.

### BACKGROUND OF THE INVENTION

The present invention relates to an item setting device, and the control method and program for the device. The present invention particularly relates to an item setting device for setting based on user operations for an item which is displayed on a switchable screen that can be changed by selecting a desired tab out of a plurality of tabs, and the control method and program for the device.

In a printing system, when a user performs printing using a printer, the user sets each setting item to a desired setting value on a PC (personal computer) using a control program called the printer driver, and sets the print conditions, whereby the printing operation is performed by the printer. As the capabilities of the printer are enhanced to permit various forms of print conditions to be set, the number of setting items tends to increase in a printer driver.

Thus, a plurality of setting items are classified according to related functions, and are associated by tabs, whereby the visibility and maneuverability of the printer driver are being improved. In this case, when the user sets the desired print conditions, the user selects a tab and changes the operation screen so that a desired setting item may be displayed and the setting item is set (changed), according to the conventional method.

Thus, when the user has to change a plurality of setting items associated with different tabs to set the print conditions, the print condition setting work is complicated.

In one of the techniques proposed against this background, the mutual setting items which have inherently different attributes and cannot be shifted can be freely replaced as the setting items desired by the user, and the user can freely update the design of the screen containing the setting items having different attributes (Japanese Patent Application Publication No. Hei 11 (1999)-53137).

However, this technique is intended to ensure that the setting items in one print setting screen are shifted to another screen. The setting items to be shifted are deleted from the original screen. Thus, the setting item desired by the user may not be found when an attempt is made to search for the screen corresponding to the relevant function. Thus, this technique is accompanied by the difficulties in finding a screen containing the desired setting item.

In another proposed technique, the setting items frequently set by the user are registered, and the registered setting items are displayed on a specific operation screen on a concentrated basis (Non-Patent Literature: Printer Driver of the PostScript 3 Printer Controller made by EFI (Electronics For Imaging, Inc), Image Controller IC-409, [online], Sep. 29, 2008, Konica Minolta, Internet <URL: http://konicaminolta.jp/business/download/copiers/efi/detail.html>).

However, the printer driver based on this technique is designed in such a way that one same tab holds all the setting items. If the user clicks on the specific icon displayed when that tab has been selected, only the setting items registered by the user operation are displayed in a limited way. Thus, when the setting items registered by the user are to be displayed, the user is required to go through the complicated procedure of clicking on a specific icon after selecting the tab. Further, in the usual printer driver, a plurality of setting items are classified according to functions, and are associated with tabs, respectively. A desired setting item is displayed by tab selection. By contrast, in the printer driver based on this technique, mere tab selection cannot ensure a desired setting item to be displayed. This will give a sense of incompatibility in operations.

In view of the technological problems described above, it is an object of the present invention to provide an item setting device in which means are provided to avoid the cases where the location of the item cannot be identified when an item to be set is shifted from one screen to another, and to ensure that the screen of the editable tab in which the items contained can be edited, and the editable tab selectably displayed as well as the fixed tab can be displayed by simple operations, without giving the user a sense of incompatibility. Another object of the present invention is to provide the control method and program for the aforementioned item setting device.

### SUMMARY

To achieve at least one of the abovementioned objects, an item setting device reflecting one aspect of the present invention comprises the followings.

(1) An item setting device which conducts setting based on operation of a user, for items which are displayed on a screen which can be switched by selecting a desired tab from a plurality of tabs, with the item setting device including an item information holding section which holds item information relating to display of fixed items of a fixed tab, a fixed tab display control section for displaying a screen of the fixed tab selected by the user by using the item information of the fixed tab, a display information holding section which holds display item information relating to which items held in the fixed tabs are to be displayed on a screen of an editable tab and the display position information relating to display positions of the items to be displayed on the screen of the editable tab with the editable tab being selectable from among the tabs including the fixed tabs and having the items which can be edited, and an editable tab display control section for creating and displaying the screen of the editable tab selected by the user, using the display item information, the display position information and the item information of the fixed tab.

(2) The item setting device of the above item (1), wherein the display information holding section comprises a display item information holding section for holding the display item information, and a display position information holding section for holding the display position information.

(3) The item setting device of the above item (1), wherein the item information comprises information about a content, a size of a display area and a display position about the item held in the fixed tab, and the editable tab display control section uses the information about the content and the size of the display area about the item in the item information.

(4) The item setting device of the above item (1), wherein the editable tab display control section creates the screen on which the item specified by the display item information is arranged at the display position specified by the display position information, based on the item information of the fixed tab.

(5) The item setting device of the above item (1), wherein the display position information can be edited by the user.

(6) The item setting device of the above item (1), wherein the item is for setting a print condition.

### BRIEF DESCRIPTION OF THE DRAWINGS

FIG. 1 is a block diagram representing the overall structure of a printing system in an embodiment of the present invention.

FIG. 2 is a block diagram representing the structure of the PC shown in FIG. 1.

FIG. 3 is a diagram showing the basic structure of a printer driver.

FIG. 4 is a flow chart showing the procedure of display processing on the print setting screen.

FIG. 5 is a diagram showing an example of item information.

FIG. 6 is a diagram showing an example of a fixed tab screen.

FIG. 7 is a diagram showing an example of an editability list.

FIG. 8 is a diagram showing an example of a group information list.

FIG. 9 is a table showing the information on each setting item.

FIG. 10 is a diagram showing an example of an edit screen.

FIG. 11 is a diagram showing the case where a screen edit instruction is given directly on the editable tab screen.

FIG. 12 is a diagram showing the case where the edit instruction of the editable tab screen is given on the fixed tab screen.

FIG. 13 is a diagram showing an example of the display item list.

FIG. 14 is a flow chart representing the procedure of display processing of the editable tab screen.

FIG. 15 is a diagram showing an example of the display item list after the edition.

FIG. 16 is a diagram showing an example of the editable tab screen displaying the state of the display item list in FIG. 13.

FIG. 17 is a diagram showing an example of the editable tab screen on which the state of the display item list of FIG. 15 having been edited is displayed after the state of the display item list of FIG. 13 has been displayed.

### DETAILED DESCRIPTION OF THE PREFERRED EMBODIMENTS

Referring to the drawings, a preferred embodiment of the present invention will be detailed in the following.

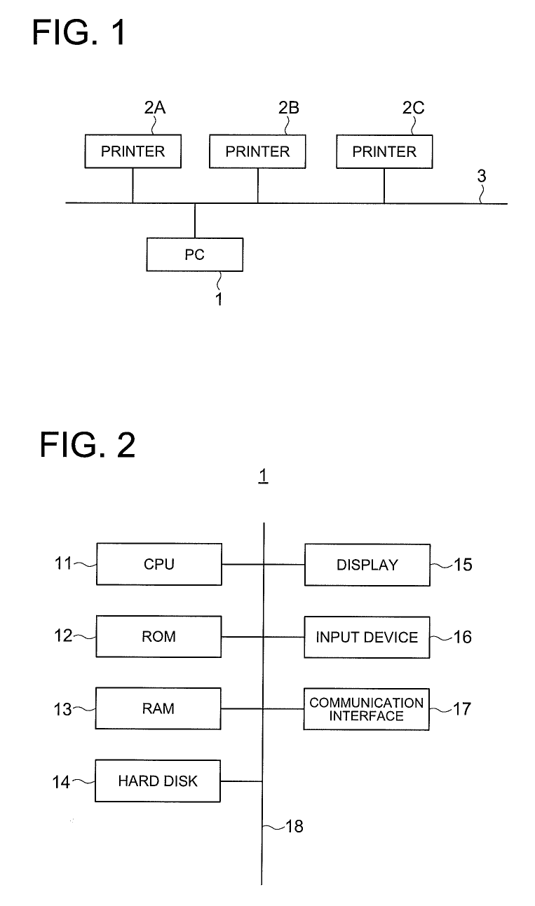

FIG. 1 shows a block diagram indicating an overall configuration of a printing system embodied in the present invention.

As shown in FIG. 1, the printing system embodied in the present invention is constituted by a PC1 (Personal Computer 1), printers 2A, 2B and 2C, which are communicatively coupled to each other through a network 3. In this connection, the number of apparatuses and kinds of apparatuses, which are to be coupled to the network 3 are not limited to those shown in FIG. 1. Further, it is also applicable that the PC1 is directly coupled to the printers 2A, 2B and 2C without employing the network 3 (local connection).

For instance, the network 3 is composed of various kinds of networks such as a LAN (Local Area Network) in which computers and networking apparatuses are coupled to each other based on the specifications complying with Ethernet, the token ring, the FDDI (Fiber Distributed Data Interface) for example, and a WAN (Wide Area Network) in which plural LANs are coupled to each other through an exclusive communication line.

FIG. 2 shows a block diagram indicating a configuration of the PC shown in FIG. 1. The PC1 is provided with a CPU (Central Processing Unit) 11, a ROM (Read Only Memory) 12, a RAM (Random Access Memory) 13, a hard disk 14, a display 15, an input device 16 and a communication interface 17, which are coupled to each other through a bus 18 for transacting signals between them.

The CPU 11 executes control for abovementioned sections and various kinds of computational processing according to programs. The ROM 12 stores various kinds of programs and various kinds of data therein. The RAM 13 serves as a working area to temporarily store the programs and the data. Further, the hard disk 14 stores various kinds of programs including an operating system (OS) and various kinds of data, therein.

The display section 15 is constituted by a CRT (Cathode Ray Tube) or an LCD (Liquid Crystal Display) or the like so as to display various kinds of information thereon. The input device 16 includes a pointing device such as a mouse, and a keyboard, which are used for conducting various kinds of input operations.

The interface section 17 serves as an interface for communication with the other apparatuses, including the printers 2A, 2B and 2C through the network 3. Local connection interfaces including network interfaces which comply with a standard such as the Ethernet, the token ring and the FDDI, a serial interface such as the USB (Universal Serial Bus) and the IEEE1394, a parallel interface such as the SCSI (Small Computer System Interface) and the IEEE1284, a wireless interface including the Bluetooth (Registered Trademark), the IEEE802.11, the HomeRF (Home Radio Frequency) and the IrDA (Infrared Data Association), and the telephone line interface for connecting to the telephone line can be employed as the interface section 17.

Further, an application program for creating a document file and the printer driver are installed in advance into the hard disk 14. The printer driver is employed not only for setting the printing conditions based on the operations conducted by the user using a print setting screen to be detailed later, but also for creating a print job in such a format that is processable for the printers 2A, 2B and 2C, based on document file given by the document file creating application program.

The PC1 may include other components than the aforementioned ones, or may not include some of the aforementioned components.

Through the network 3, the printers 2A, 2B and 2C receive the printing job created by the PC1, and perform printing processing according to the printing job.

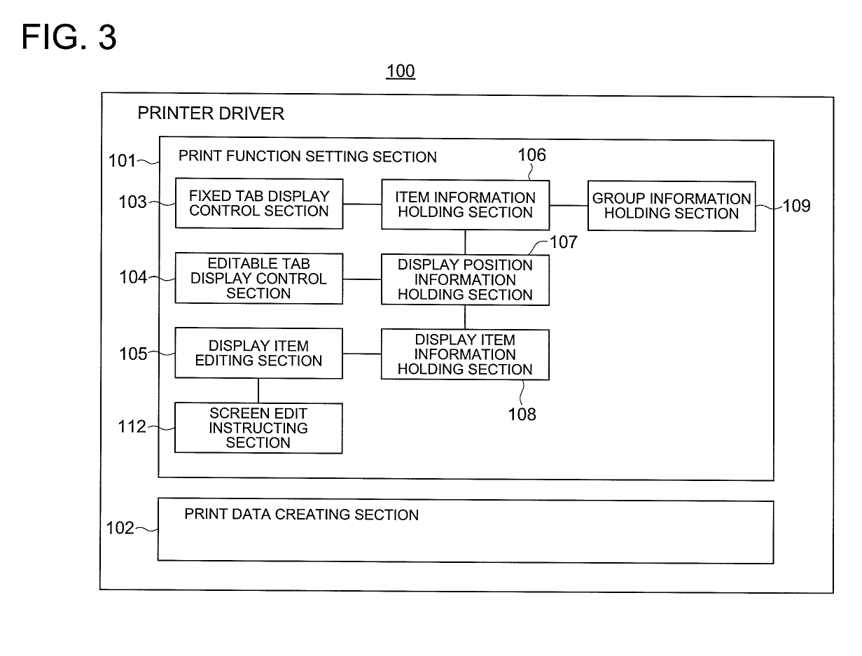

FIG. 3 is a diagram showing the basic structure of a printer driver.

The printer driver 100 is software that is installed on the OS of the PC1 as a host computer, and creates a printing job. Through the user interface, the printer driver 100 enables a user to conduct setting for using the function mounted on the corresponding printer. According to the setting, a printing job in the format that can be processed in the printers 2A through 2C can be created and sent to the printer.

The printer driver 100 includes a print function setting section 101 and print data creating section 102.

The print function setting section 101 provides a screen (GUI) that permits the user to set up desired print conditions. Fixed tabs having the fixed items whose display positions are fixed, and an editable tab permitting editing of the possessed items wherein the display position of the items can be edited are displayed on the screen displayed by the printer driver 100 of this embodiment in such a way that these tabs can be selected by the user. If the editable tab has been selected by the user, the screen associated with the editable tab (editable tab screen) is displayed. If one of the fixed tabs has been selected by the user, the screen associated with the selected fixed tab (fixed tab screen) is displayed. The information set on the screen is handed over to the print data creating section 102.

Based on the document file created by the application installed on the OS, the print data creating section 102 creates the printing job in the format that can be processed in the printers 2A through 2C.

As shown in FIG. 3, the print function setting section 101 includes an item information holding section 106, fixed tab display control section 103, display item information holding section 108, display position information holding section 107, editable tab display control section 104, display item editing section 105, screen edit instructing section 112 and group information holding section 109.

The item information holding section 106 holds the item information on the display of the items registered in the fixed tab. To put it more specifically, the item information is the information for each item (also referred to as “control”) as exemplified by information for an ID, type (text, radio button, check box, image and others), display position (coordinate), size of the display area (length and width) and line of characters to be displayed.

The fixed tab display control section 103 provides control for reading the item information of the fixed tab and displaying a specific fixed tab screen.

The display item information holding section 108 holds the display item information about which item of the items held by the fixed tab should be displayed on the editable tab screen.

The display position information holding section 107 holds the display position information on the display position of the item to be displayed on the editable tab screen.

The editable tab display control section 104 controls the display of the editable tab screen.

The display item editing section 105 performs editing operations such as addition, shift and deletion of the item to be displayed on the editable tab screen. To put it more specifically, the display item editing section 105 edits the item displayed on the editable tab screen, and the display position.

The screen edit instruction section 112 receives the user's instruction for editing the item to be displayed on the editable tab screen. When the user gives an instruction to change the item displayed on the editable tab screen and the display position, the screen edit instruction section 112 gives a screen editing instruction to the display item editing section 105.

For all the items displayed by the printer driver, the group information holding section 109 holds the group information indicating the group of the setting item (function) to which the item belongs. In this case, the setting item is made up of a plurality of items (controls).

The functions of the print function setting section 101 and print data creating section 102 are fulfilled when the program stored in the hard disk 14 is read out onto the RAM 13 and is executed by the CPU 11. A predetermined storage area is assigned to each of the item information holding section 106, display item information holding section 108, display position information holding section 107, and group information holding section 109.

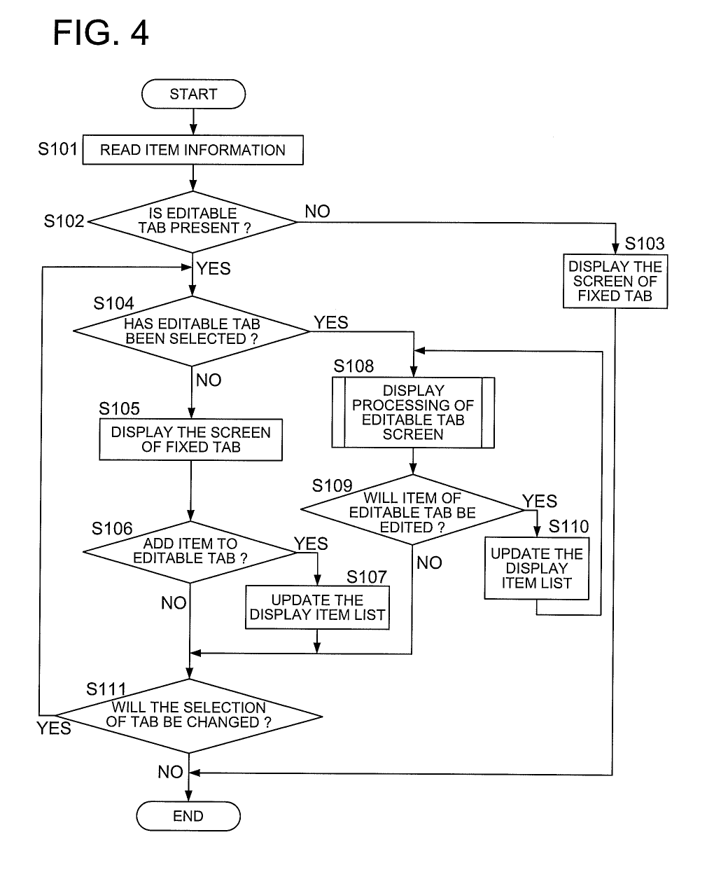

Referring to FIG. 4, the following describes the operation of the print function setting section 101.

FIG. 4 is a flow chart showing the procedure for display processing of the print setting screen.

In the first place, the item information on the fixed tab is read (S101).

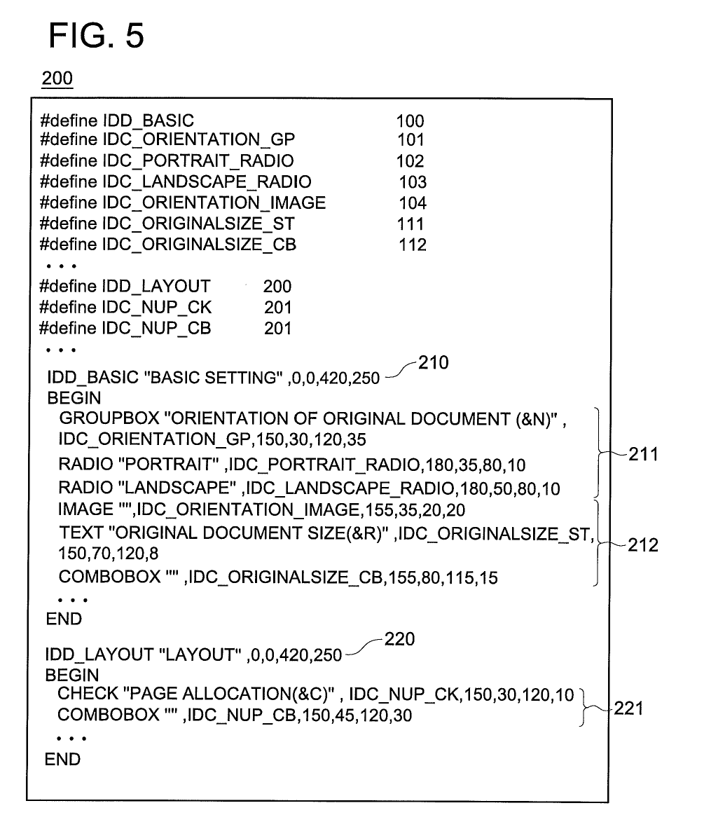

FIG. 5 is a diagram showing an example of item information. In this case, the “basic setting” tab information 210 and “layout” tab information 220 are exemplified as a part of the item information. Further, the “basic setting” tab information 210 includes the “document orientation” information 211 and “original document size” information 212. The “layout” tab information 220 includes the “page allocation” information 221.

In the next step, a decision is made to see whether the editable tab is present or not (S102).

The setting of whether the editable tab is present or not is carried out at the time of developing the printer driver. Not only that, this setting can also be adjusted by the user (or administrator). If the setting is carried out at the time of developing the printer driver in such a way that there is no editable tab, the printer driver includes only fixed tabs (as is the case with the conventional printer driver). In the printer driver including an editable tab, if the setting is made by the user in such a way that the printer has no editable tab, the editable tab is not displayed on the screen.

If there is no editable tab (S102: NO), the fixed tab screen is displayed based on the item information having been read (S103).

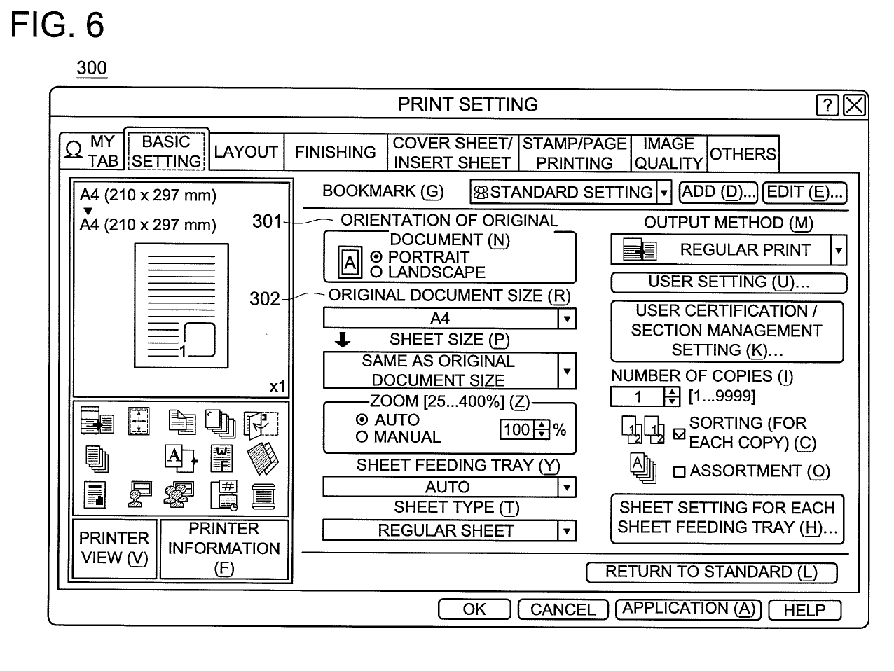

If the editable tab is present (S102: YES), a step is taken to determine whether or not the editable tab (shown as “My tab” in FIG. 6) has been selected (S104).

In the printer driver 100 of the present embodiment, the setting is made so that the editable tab may be first displayed at the time of startup, with consideration given to convenience. It is also possible to arrange the setting in such a way that the fixed tab will be first displayed.

If the fixed tab is selected without the editable tab being selected (S104: NO), the fixed tab screen is displayed using the item information having been read (S105).

FIG. 6 is a diagram showing an example of a fixed tab screen 300.

In FIG. 6, the basic setting tab screen is being displayed according to the “basic setting” tab information 210 of the item information 200 (FIG. 5). For each setting item, the “original document orientation” 301 is displayed according to the “original document orientation” information 211 of the item information 200, and the “original document size” 302 is displayed according to the “original document size” information 212 of the item information 200.

When the editable tab has been selected (S104: YES), display processing of the editable tab screen is performed (S108). In this case, the editable tab screen is displayed collectively for each group. Display processing of the editable tab screen will be described in detail later.

In Step S109, a decision is made to see whether or not the printer operation has been made to edit the item to be registered in the editable tab.

When the editable tab screen is to be terminated without the editable tab item being edited (S109: NO), a step is taken to determine whether or not the tab selection has been changed by the user (S111).

When the tab selection has been changed (S111: YES), the operation goes back to the processing of S104.

When the tab selection is not changed (S111: NO), the processing in FIG. 4 is terminated by the user operation such as the end of setting, cancel of setting, or start of printing.

When there is an editable tab, the item to be displayed on the editable tab screen can be added or edited by registration in the editable tab (S106, S109).

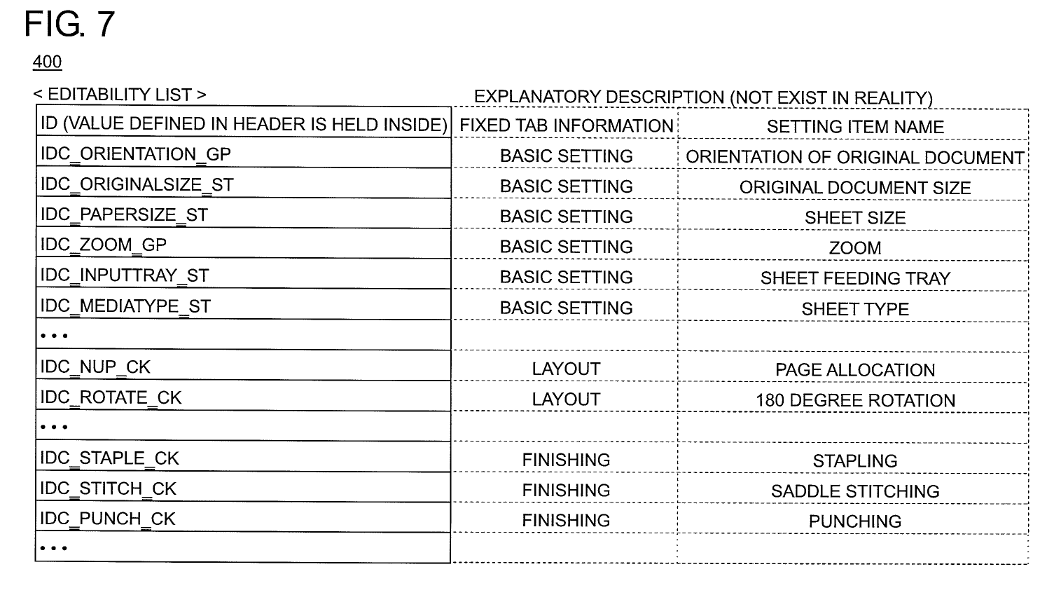

FIG. 7 is a diagram showing an example of the list (editability list) for all the items that can be registered in the editable tab. This editability list 400 does not include items common to all the tabs (such as sheet view) or items specific to the fixed tab. The description in the broken line frame shown on the right side of FIG. 7 is given for the purpose of explanation, and does not indicate substantial data. (This also applies to the description in the broken line frame appearing in the subsequent diagrams).

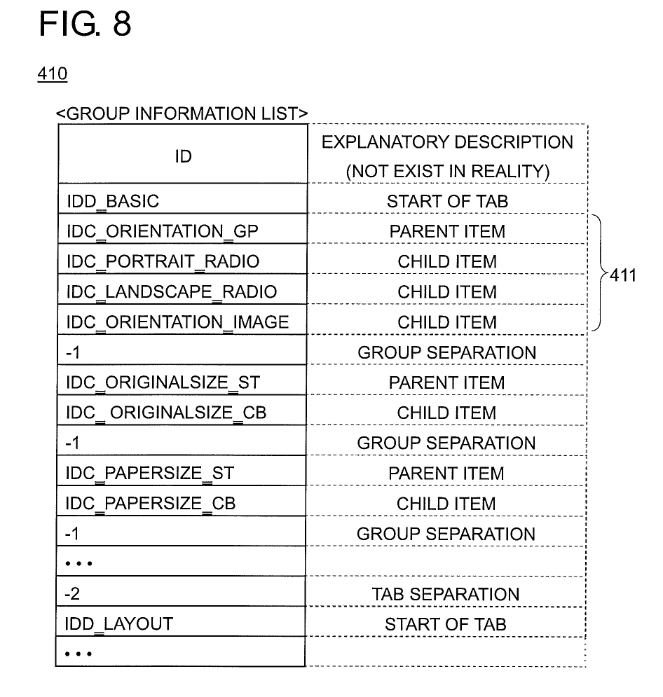

FIG. 8 shows an example of the list of the group information (group information list) showing the group of the setting items to which each of a plurality of items (control) belongs. For example, as indicated by the reference numeral “411” in the group information list 410 of FIG. 8, the setting item for “original document orientation” 301 (FIG. 6) is made up of a plurality of items such as a group box, two radio buttons, and image. To be more specific, one setting item can be said to consist of a group of a plurality of items. In order to handle a plurality of items having unity in terms of functions as a group in this manner, in the present embodiment, the item representative of the group, i.e., the parent item of the group is determined, and setting items are handled in groups using the parent item. For example, for the setting items of the “original document orientation” 301 of FIG. 6, the “original document orientation” group box is the parent item. For the setting items of the “original document size” 302, the “original document” size text is the parent item (FIG. 5).

In the following description, the name of the setting items as a group (ID is described by means of the parent item) is mentioned. In this case, all the items in the group are processed at the same time. The group information list 410 could be incorporated in the aforementioned item information 200 or editability list 400.

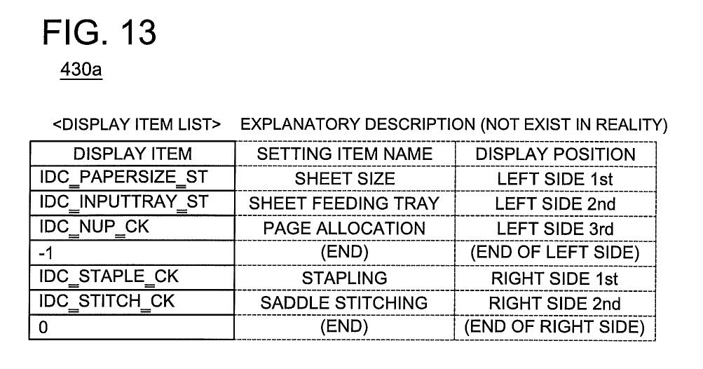

If it is determined in Step S109 that the user has operated to edit the item to be registered in the editable tab (S109: YES), the display item list is updated (S110), and the operation goes back to Step S108. The display item list is a display item information list that indicates which item of the items held by the fixed tab should be displayed on the editable tab screen (FIG. 13).

In Step S106, a decision is made to see whether or not the user has operated to add an item to be registered in the editable tab. If it is determined that the user has not operated to add an item to be registered in the editable tab (S106: NO), and the operation proceeds to Step S111.

If it is determined in Step S106 that the user has operated to add an item to be registered in the editable tab (S106: YES), the display item list is updated (S107), and the operation goes to Step S111.

The following methods are available to edit the item displayed on the editable tab screen and the display position thereof. One is the method (a) where the item is edited by displaying the edit screen. The other is the method (b) where the setting item is shifted in the vertical and lateral directions or is deleted using the menu displayed by right-clicking on the item inside the editable tab screen. Still another is the method (c) where a setting item is added using the menu displayed by right-clicking on the item inside the fixed tab screen. As described above, clicking on any item out of the setting items provides an instruction to edit all the setting items to which the clicked item belongs.

The following describes the process of editing the item to be registered in the editable tab. The item registered in the editable tab is displayed on the editable tab screen.

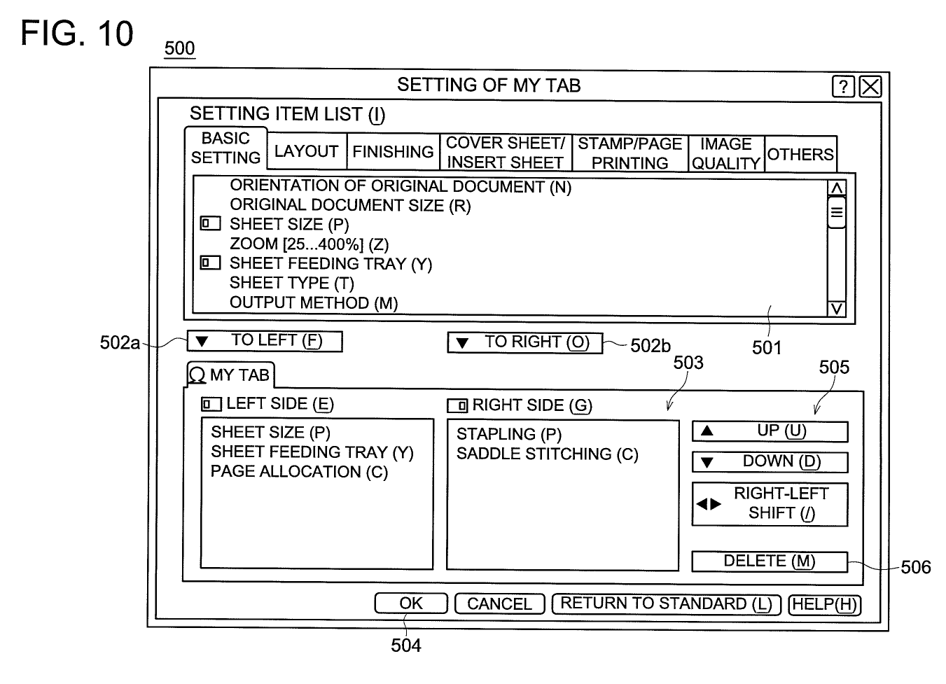

According to the method (a), the edit screen for editing the editable tab screen shown in FIG. 10 is displayed at first. The upper display section 501 of the edit screen 500 displays the list for all the items that can be displayed on the editable tab screen by reference to the editability list 400 (FIG. 7). The editability list 400 to be referenced is a parent list which is made up of a plurality of items and is representative of the setting items as a group responsible for print functions. The parent item of the group is displayed on the upper display section 501 of FIG. 10. (This is also applicable to the lower display section 503).

The lower display section 503 of the edit screen 500 displays a list for the items registered in the editable tab and displayed on the editable tab screen actually. In the initial state, the items originally registered in the editable tab are displayed on the lower display section 503. The items on the editable tab screen can be added or their position can be changed by editing the editable tab.

An item is selected on the upper display section 501 of the edit screen 500 and the “TO LEFT” button 502a is pressed. Then that item is added to the left of the lower display section 503. (In this case, the item is added to the left of the editable tab screen). When the “TO RIGHT” button 502b has been pressed, the item is added to the right of the lower display section 503. (In this case, the item is added to the right of the editable tab screen). Further, the position of the item displayed on the editable tab screen can be changed by pressing the “UP”, “DOWN” and “RIGHT-LEFT SHIFT” buttons 505. Further, the item to be selected can be deleted from the list on the lower display section 503 by pressing the “Delete” button 506.

If the “OK” button 504 is pressed in the final phase, the screen edit instruction to change the display on the editable tab screen is issued according to the information on the lower display section 503.

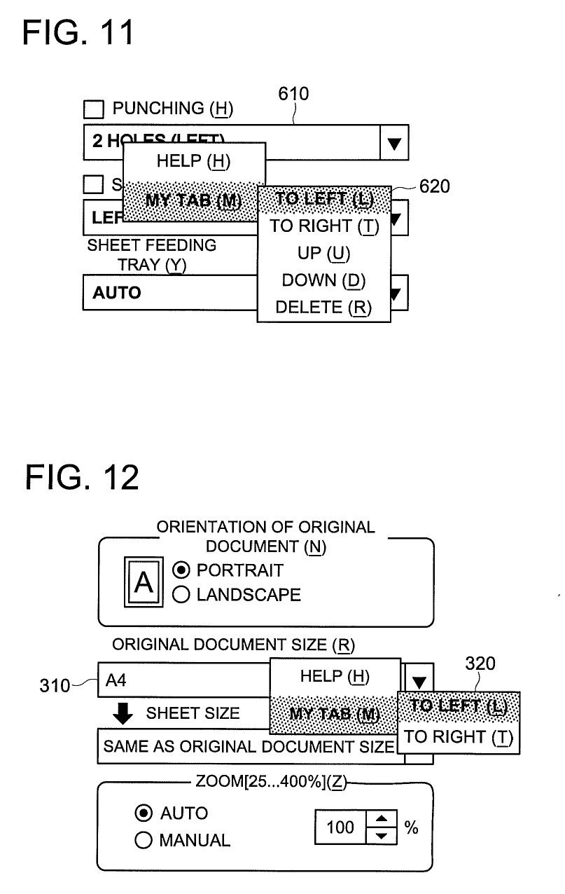

According to the method (b), an instruction is given to edit the screen directly on the editable tab screen, as shown in FIG. 11.

The menu 620 is displayed by right-clicking on the item 610 to be edited. When the user selects any one of the “TO LEFT”, “TO RIGHT”, “UP” and “DOWN” on the menu list, an instruction is given to shift the relevant item to a particular side within the editable tab screen. When “Delete” has been selected, the relevant item can be deleted from the editable tab screen.

If an instruction for the item has been given on the menu 620, reference is made to the group information list 410 (FIG. 8). Then, a step is taken to check the group to which the item belongs, and the ID of the parent item of the group is acquired. In this case, the group information list ensures that the parent item and child item belonging to the function group can be managed as a group, as described above. To be more specific, the group includes one parent item representative of the group, and a plurality of child items. The reference numeral “411” in the group information list 410 of FIG. 8 provides an example of the unity as a group of this list. A screen edit instruction is given to update the display on the editable tab screen according to the acquired ID of the parent item and the instruction from the menu 620.

According to the method (c), an edit instruction of the editable tab screen is given on the screen of the fixed tab, as shown in FIG. 12 (S106).

The menu 320 is displayed by right-clicking on the item 310 desired to be added to the editable tab screen out of the items appearing on the fixed tab screen. The user can give an instruction to add the relevant item to the left of the editable tab screen by selecting “TO LEFT” of the menu list, and to the right of the editable tab screen by selecting “TO RIGHT”. It should be noted that the item to be added is added to the last of the items already displayed.

If the instruction is given to an item on this menu 320, reference is made to the group information list 410 (FIG. 8), similarly to the case of method (b). Then a step is taken to check the group to which the item belongs, and the ID of the parent item of the group is acquired. This is followed by the step of giving a screen edit instruction to update the display on the editable tab screen according to the acquired ID of the parent item and the instruction from the menu 320.

In the present embodiment, the user's instructions for such editing operations as addition, shift or deletion of the item displayed on the editable tab screen are accepted collectively for each group according to the group information held in advance, as described above.

When the screen edit instruction has been given, the display item list is updated, as described above (S107, S110).

FIG. 13 shows an example of the display item list. This display item list 430a also provides the information on the position displayed (arranged) on the editable tab screen. To be more specific, the display item list serves as a display information holding section that holds the display item information for indicating which of the items held by the fixed tab should be displayed on the editable tab screen, and the display position information on the position of the item to be displayed on the editable tab screen.

The display item list 430a contains the IDs of the parent items which are representative of the setting items as a group consisting of a plurality of items, and arranged in the order from the top left of the editable tab screen. The items indicated by the IDs before “−1” on the display item list are placed on the left side of the editable tab screen, and the items indicated by the IDs between “−1” and “0” on the display item list is placed on the right side of the editable tab screen. FIG. 13 shows that items are displayed on the left side of the editable tab screen in the order of “sheet size”, “sheet feeding tray” and “page allocation”, and on the right side of the editable tab screen in the order of “stapling” and “saddle stitching”. Thus, the display on the editable tab screen is updated according to the information of the display item list. To put it more specifically, the child items belonging to the group indicated by the parent item are put together with the parent item, and processing is performed. To put it another way, in the present embodiment, such editing operations as addition, shift and deletion of the items to be displayed on the editable tab screen are performed collectively for each group according to the group information held in advance.

Display processing of the editable tab screen is performed according to the new display item list immediately after the display item list has been updated (S107, S110) if the editable tab screen is currently displayed, or immediately after the display has been changed to the editable tab screen next if the screen of the fixed tab is currently displayed (S108).

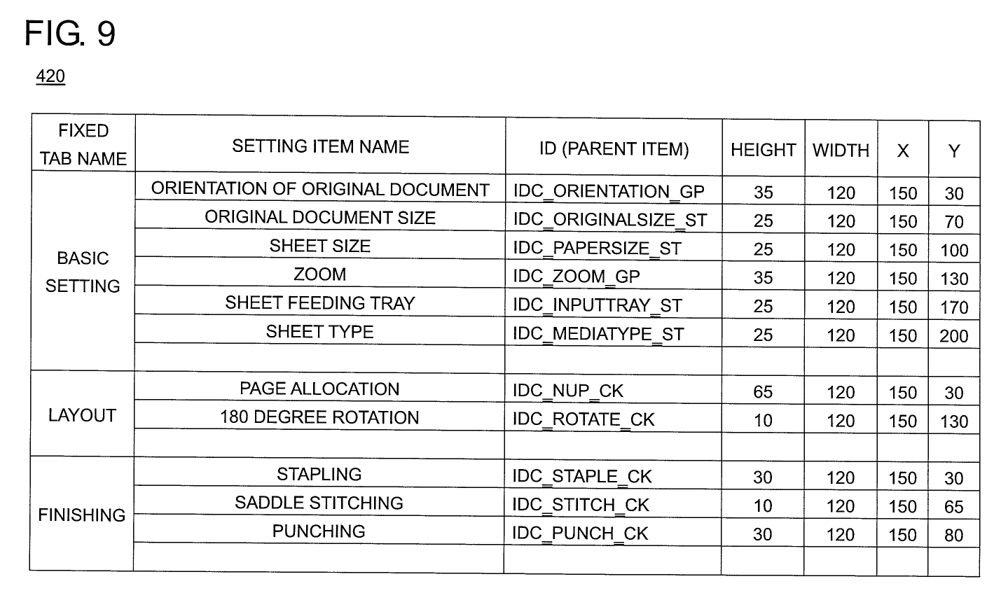

FIG. 9 uses a table to indicate the information of each item according to the item information, editability list, and group information list having been described so far. In the item information table 420 of FIG. 9, in the state of classification into groups, the height, width, X and Y of the setting items indicates the coordinate values when they are displayed on the fixed tab screen. The following description refers to the setting item information of FIG. 9.

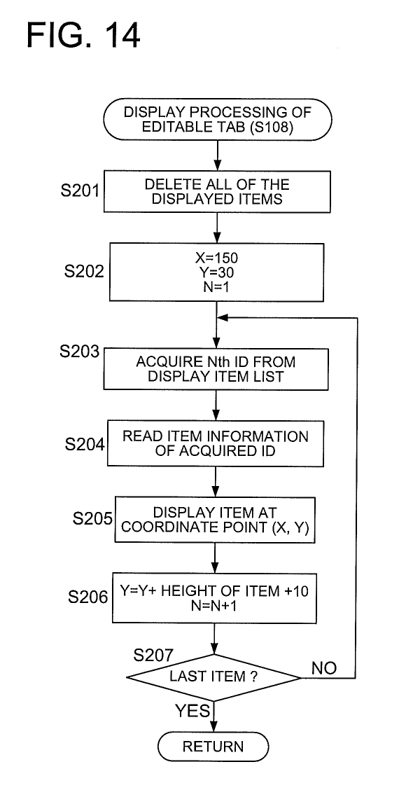

Referring to FIG. 14, display processing of the editable tab screen will be described.

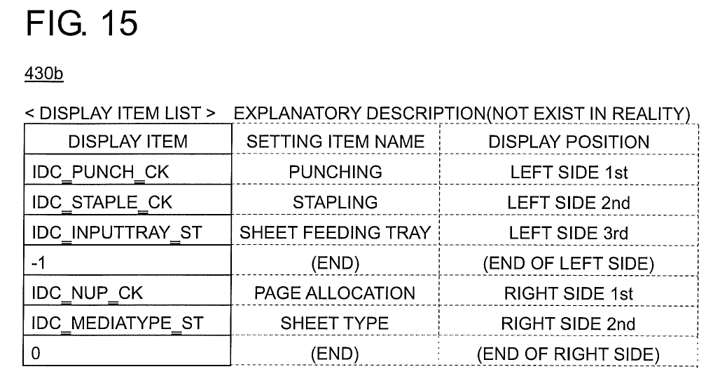

In this case, the following two cases will be explained. In the first example, the state of the display item list 430a of FIG. 13 is displayed. In the second example, after the state of the display item list 430a of FIG. 13 has been displayed, the editing operation is performed to get a display item list 430b of FIG. 15.

The following describes the first example. At first, all the items displayed on the editable tab screen are deleted (S201). In this case, it is assumed that the editable tab screen is display for the first time, without any item to be deleted.

This is followed by the step of giving the initial values for the coordinates required to display the first item (S202). In this case at first, X=150 and Y=30 are given as the initial values for the coordinates required to display the first item in the display area on the left of the editable tab screen. The coordinates are represented in terms of pixels. Other units such as points can be used. “N” indicates the order of appearance (given separately on the left and right display areas) in the display item list 430a, and the initial value thereof is N=1.

In Step S203, the Nth ID is acquired from the display item list 430a (FIG. 13). To put it more specifically, the “IDC_PAPERSIZE_ST” (sheet size) is acquired as the ID of the first item on the left.

This is followed by the step of reading the fixed tab item information of the item of the acquired ID (S204). In this case, for the first ID on the left of the display item list 430a, the information for “IDC_PAPERSIZE_ST” is acquired from the item information 200 of the fixed tab by referencing the group information list 410. The setting item for the “IDC_PAPERSIZE_ST” is composed of the text and combination box control, and has a width of 120 and a height of 25. It should be noted that the coordinate values (X and Y of FIG. 9) on the fixed tab screen acquired at the time are not used.

Then, a step is taken to create the editable tab screen on which the items given on the display item list 430a are arranged at the display position determined by the coordinates (X, Y), based on the item information of the fixed tab having been acquired (S205). This procedure ensures that the setting item of the “sheet size” registered in the basic setting tab as the fixed tab is copied onto the editable tab screen, whereby this setting item is displayed.

This is followed by the step of adding the height of the setting item and a space to Y, and adding 1 to N (S206).

The space is assumed as 10, which can be changed accordingly. In this case, Y=30+25+10=65, and N=2.

In Step S207, a decision is made to see whether the processing of the last item in the display item list 430a has terminated or not.

If the processing of the last item has not yet terminated (S207: NO), the operation goes back to Step S203.

For example, when the processing of the first item on the left of the display item list 430a has terminated, the processing of the last item is not yet terminated, and therefore, the processing of the second item on the left is performed. The setting item for “IDC_INPUTTRAY_ST” (sheet feeding tray) is displayed at the coordinates (150, 65) by the processing of the second item on the left.

When the processing for displaying the last setting item “IDC_NUP_CK” (page allocation) has terminated through repetition of Steps S203 through S207 in the manner described above (S207: YES), the processing of FIG. 14 terminates.

Similarly, processing is performed to display the item in the display area on the right of the editable tab screen. In this case, X=280 and Y=30 are the initial values for the coordinates required to display the first item. The setting items for “IDC_STAPLE_CK” (stapling) and “IDC_STITCH_CK” (saddle stitching) are displayed in the display area on the right of the editable tab screen and the processing terminates.

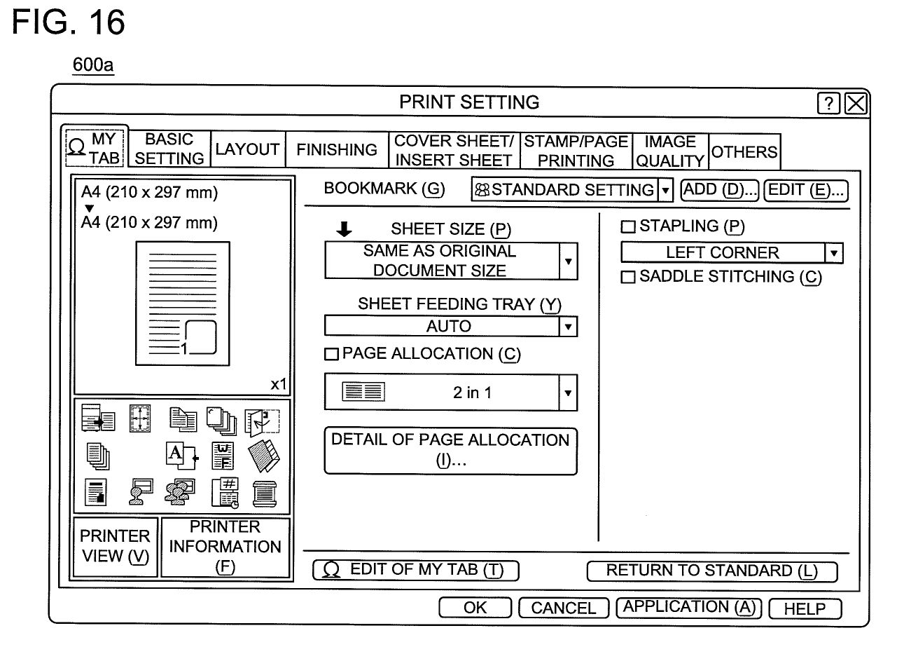

FIG. 16 shows an example of the editable tab screen 600a displaying the state of the display item list 430a of FIG. 13.

The second example will be explained below. At first, all the items displayed on the editable tab screen are deleted (S201). In this case, the items displayed in the first example are deleted.

This is followed by the step of giving the initial values for the coordinates required to display the first item, similarly to the case of the first example (S202). X=150 and Y=30 are the coordinates on the left display area given as the initial values. X=280 and Y=30 are the coordinates on the right display area given as the initial values. Further, the space is 10.

In Step S203, the Nth ID is acquired from the display item list 430b (FIG. 15). To put it more specifically, “IDC_PUNCH_CK” (punching) is acquired as the ID of the first item on the left in this case.

This is followed by the step of reading the item information of the fixed tab for the item of the acquired ID (S204). In this case, for the ID of the first item on the left of the display item list 430b, information of “IDC_PUNCH_CK” is acquired from the item information 200 of the fixed tab by referencing the group information list 410 at first. The setting item for the “IDC_PUNCH_CK” includes the check box control and has a width of 120 and a height of 30. The coordinate values on the acquired fixed tab screen are not used.

This is followed by the step of creating an editable tab screen in which the items given in the display item list 430b are arranged at the display position defined by coordinates (X, Y) according to the item information of the acquired fixed tab (S205). This procedure ensures that the setting item for “punching” registered in the basic setting tab as the fixed tab is copied onto the editable tab screen and is displayed.

This is followed by the step of adding the height of the setting item and a space to Y, and adding 1 to N (S206). In this case, Y=30+30+10=70, and N=2.

In Step S207, a decision is made to see whether or not processing of the last item in the display item list 430b has terminated.

If the processing of the last item has not yet terminated (5207: NO), the operation goes back to Step S203.

For example, when the processing of the first item on the left of the display item list 430b has terminated, the processing of the last item is not yet terminated, and therefore, the processing of the second item on the left side is performed. The setting item for “IDC_STAPLE_CK” (stapling) is displayed at the coordinates (150, 70) by the processing of the second item on the left.

When the processing for displaying the last setting item “IDC_INPUTTRAY_ST” (sheet feeding tray) has terminated through repetition of Steps S203 through S207 in the manner described above (S207: YES), the processing of FIG. 14 terminates.

Similarly, processing is performed to display the setting item in the display area on the right of the editable tab screen.

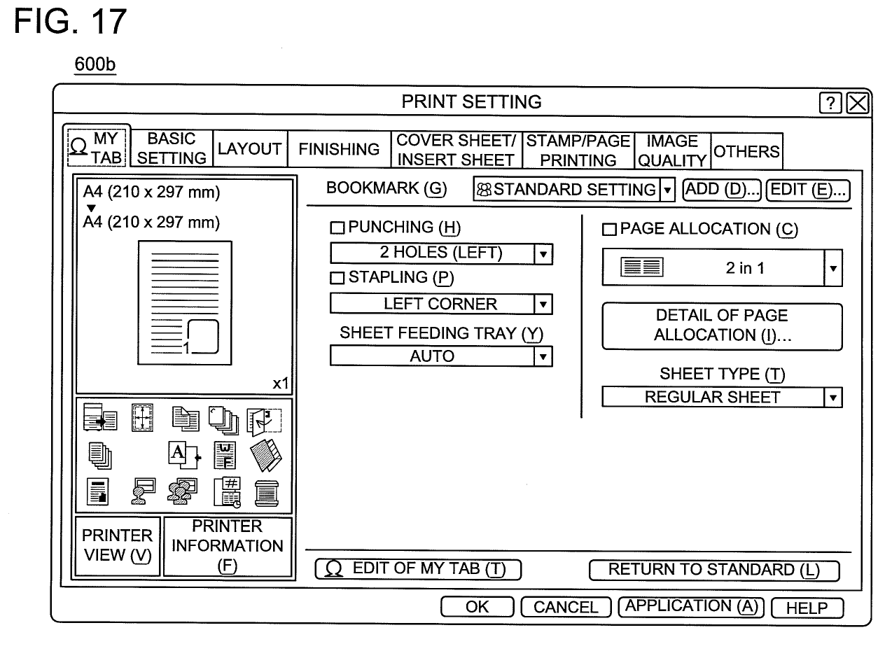

FIG. 17 shows an example of the editable tab screen 600b in which, after the state of the display item list 430a of FIG. 13 has been displayed, the state of the display item list having been edited of FIG. 15 is displayed.

As described above, in the present embodiment, the editable tab which can be displayed selectably as well as the fixed tab is selected by the user, whereby an editable tab screen is created and displayed using the display item information on which item should be displayed on the editable tab screen, the display position information on the position of the item displayed on the editable tab screen, and the item information of item included in the fixed tab.

The aforementioned arrangement avoids the cases wherein, when an item to be set is shifted from one screen to another, the location of this item cannot be identified, and ensures that the screen of the editable tab wherein the editable tab is selectably displayed as well as the fixed tab and the items held can be edited, can be displayed by simple operations, without giving a sense of incompatibility to the user. This arrangement minimizes the user's item setting time or setting errors.

It is to be expressly understood that the present invention is not restricted to the aforementioned embodiment. The present invention can be embodied in a great number of variations with appropriate modifications or additions, without departing from the technological spirit and scope of the invention claimed.

For example, in the aforementioned embodiment, the display item information showing which of the items held by the aforementioned fixed tab should be displayed on the editable tab screen, and the display position information on the position of the item to be displayed on the editable tab screen are both stored in the display item list. Without the present invention being restricted thereto, however, they can be stored in various forms of storage areas.

Further, the aforementioned embodiment has been described with reference to the item setting device for setting in conformance to the user's operation regarding the items for setting the print conditions. However, the present invention is not restricted thereto. For example, the present invention is also applicable to the item setting device in conformance to the user's operation regarding the items for setting the conditions for other services.

The means and methods for performing various forms of processing in the item setting device of the present embodiment can be implemented by either a special-purpose hardware circuit or a programmed computer. For example, the aforementioned program can be provided by a computer-readable recording medium such as a flexible disk or CD-ROM, or can be provided online through via the network such as the Internet. In this case, the program recorded on the computer-readable recording medium is usually transferred to a storage device such as a hard disk and is stored thereon. The aforementioned program can be provided as independent application software, or can be incorporated in the software of the device as a function of the item setting device.

What is claimed is:

1. An item setting device which conducts setting based on operation of a user, for items which are displayed on a screen which can be switched by selecting a desired tab from a plurality of tabs, the item setting device comprising:
an item information holding section which holds item information relating to display of fixed items of a fixed tab;
a fixed tab display control section for displaying a screen of the fixed tab selected by the user by using the item information of the fixed tab;
a display information holding section which holds display item information and display position information, the display item information relating to which items held in the fixed tabs are to be displayed on a screen of an editable tab and the display position information relating to display positions of the items to be displayed on the screen of the editable tab, the editable tab being selectable from among the tabs including the fixed tabs and having the items which can be edited; and
an editable tab display control section for creating and displaying the screen of the editable tab selected by the user, using the display item information, the display position information and the item information of the fixed tab.

2. The item setting device of claim 1,
wherein the display information holding section comprises:
a display item information holding section for holding the display item information; and
a display position information holding section for holding the display position information.

3. The item setting device of claim 1,
wherein the item information comprises information about a content, a size of a display area and a display position about the item held in the fixed tab, and the editable tab display control section uses the information about the content and the size of the display area about the item in the item information.

4. The item setting device of claim 1,
wherein the editable tab display control section creates the screen on which the item specified by the display item information is arranged at the display position specified by the display position information, based on the item information of the fixed tab.

5. The item setting device of claim 1,
wherein the display position information can be edited by the user.

6. The item setting device of claim 1,
wherein the item is for setting a print condition.

7. A computer-readable recording medium which stores a program for an item setting device which conducts setting based on operation of a user, for items which are displayed on a screen which can be switched by selecting a desired tab from a plurality of tabs, the program making the item setting device implement the steps of:
(a) displaying a screen of a fixed tab selected by the user by using item information of the fixed tab which is stored in an item information holding section which holds the item information relating to display of fixed items of the fixed tab; and
(b) creating and displaying a screen of an editable tab selected by the user, using display item information, display position information and the item information of the fixed tab, the display item information and the display position information being stored in a display information holding section which holds the display item information and display position information, the display item information relating to which items held in the fixed tabs are to be displayed on the screen of the editable tab and the display position information relating to display positions of the items to be displayed on the screen of the editable tab, the editable tab being selectable from among the tabs including the fixed tabs and having the items which can be edited.

8. The computer-readable recording medium of claim 7,
wherein the display information holding section comprises:
a display item information holding section for holding the display item information; and
a display position information holding section for holding the display position information.

9. The computer-readable recording medium of claim 7,
wherein the item information comprises information about a content, a size of a display area and a display position about the item held in the fixed tab, and in the creating and displaying step (b), the information about the content and the size of the display area about the item in the item information is used.

10. The computer-readable recording medium of claim 7,
wherein in the creating and displaying step (b), the screen on which the item specified by the display item information is arranged at the display position specified by the display position information, based on the item information of the fixed tab, is created.

11. The computer-readable recording medium of claim 7,
wherein the display position information can be edited by the user.

12. The computer-readable recording medium of claim 7,
wherein the item is for setting a print condition.

13. A control method for an item setting device which conducts setting based on operation of a user, for items which are displayed on a screen which can be switched by selecting a desired tab from a plurality of tabs, the control method comprising the steps of:
(a) displaying a screen of a fixed tab selected by the user by using item information of the fixed tab which is stored in an item information holding section which holds the item information relating to display of fixed items of the fixed tab; and
(b) creating and displaying a screen of an editable tab selected by the user, using display item information, display position information and the item information of the fixed tab, the display item information and the display position information being stored in a display information holding section which holds the display item information and display position information, the display item information relating to which items held in the fixed tabs are to be displayed on the screen of the editable tab and the display position information relating to display positions of the items to be displayed on the screen of the editable tab, the editable tab being selectable from among the tabs including the fixed tabs and having the items which can be edited.

14. The control method of claim 13,
wherein the display information holding section comprises:
a display item information holding section for holding the display item information; and
a display position information holding section for holding the display position information.

15. The control method of claim 13,
wherein the item information comprises information about a content, a size of a display area and a display position about the item held in the fixed tab, and in the creating and displaying step (b), the information about the content and the size of the display area about the item in the item information is used.

16. The control method of claim 13,
wherein in the creating and displaying step (b), the screen on which the item specified by the display item information is arranged at the display position specified by the display position information, based on the item information of the fixed tab, is created.

17. The control method of claim 13,
wherein the display position information can be edited by the user.

18. The control method of claim 13,
wherein the item is for setting a print condition.
